(19) United States
(12) Patent Application Publication
(10) Pub. No.: US 2022/0063527 A1
(43) Pub. Date: Mar. 3, 2022

(54) ELECTRICAL TRANSFER DEVICE

(71) Applicant: Ford Global Technologies, LLC, Dearborn, MI (US)

(72) Inventors: Michael Adel Awad Alla, Novi, MI (US); Ray Siciak, Ann Arbor, MI (US); Daniel J. Martin, Plymouth, MI (US)

(73) Assignee: Ford Global Technologies, LLC, Dearborn, MI (US)

(21) Appl. No.: 17/004,443

(22) Filed: Aug. 27, 2020

(51) Int. Cl. B60R 16/033; B60L 58/12; B60L 50/60; B60L 53/20

(52) U.S. Cl. CPC B60R 16/033; B60L 58/12; B60L 2210/10; B60L 53/20; B60L 50/60

(57) ABSTRACT

An electrical power device includes a plurality of switches and a plurality of interfaces configured to removably couple with a corresponding battery of a vehicle. Each switch of the plurality of switches is connected to an interface of the plurality of interfaces and another switch of the plurality of switches. The electrical power device also includes a controller programmed to transition at least a first switch of the plurality of switches from an open state to a closed state based on a charge state of a first battery such that the first switch electrically connects the first battery to a second battery of the vehicle in the closed state.

### BACKGROUND

Hybrid-electric, electric, and conventional (internal-combustion engine) vehicles typically include a power system for supplying power to various loads. The power system typically includes a low-voltage battery, e.g., 12 or 48 volts, which can supply energy to the loads. In a hybrid-electric vehicle, the power system includes a DC/DC converter that supplies power to the loads unless the power demanded by the loads exceeds the capacity of the DC/DC converter, in which case the low-voltage battery supplies the loads. In some instances, a vehicle system may download and/or upload data. When the vehicle is inactive, the vehicle system may draw power from the low-voltage battery to complete downloading and/or uploading the data.

### BRIEF DESCRIPTION OF THE DRAWINGS

FIG. 1 is a block diagram of elements of an example vehicle.

FIG. 2 is a block diagram of an example propulsion system of the vehicle of FIG. 1.

FIG. 3 is a circuit diagram of an example power-distribution system of the vehicle of FIG. 1 that includes an electrical transfer device connected to batteries of the power-distribution system.

FIG. 4 is a block diagram of the electrical transfer device.

FIG. 5 is a process flow diagram of an example process for routing electrical power between the batteries of the power-distribution system with the electrical transfer device.

### DETAILED DESCRIPTION

An electrical power device includes a plurality of switches and a plurality of interfaces configured to removably couple with a corresponding battery of a vehicle. Each switch of the plurality of switches is connected to an interface of the plurality of interfaces and another switch of the plurality of switches. The electrical power device also includes a controller programmed to transition at least a first switch of the plurality of switches from an open state to a closed state based on a charge state of a first battery such that the first switch electrically connects the first battery to a second battery of the vehicle in the closed state.

In other features, the controller is further programmed to transition at least a second switch of the plurality of switches to a closed state based on the charge state of the first battery, wherein the second switch is disposed between the first switch and the second battery.

In other features, the first battery and the second battery comprise low-voltage batteries.

In other features, the first battery and the second battery provide power to corresponding power-distribution boards within the vehicle.

In other features, the controller is further programmed to compare the charge state of the first battery to a predetermined charge threshold when a power-distribution board connected to the first battery is at least one of uploading data or downloading data.

In other features, the electrical transfer device includes charge sensing circuitry disposed between at least one interface of the plurality of interfaces and the controller, wherein the charge sensing circuitry measures the charge state of the first battery and provides a signal indicative of the charge state to the controller.

In other features, the sensing circuitry comprises an amplifier.

An electrical power device includes a plurality of switches and a plurality of interfaces configured to removably couple with a corresponding battery of a vehicle. Each switch of the plurality of switches is connected to an interface of the plurality of interfaces and another switch of the plurality of switches. The electrical power device also includes a controller programmed to transition at least a first switch of the plurality of switches from an open state to a closed state based on a charge state of a first battery such that the first switch electrically connects the first battery to a second battery of the vehicle in the closed state. The electrical power device also includes a housing that at least partially encloses the plurality of switches, the plurality of interfaces, and the controller.

In other features, the controller is further programmed toy transition at least a second switch of the plurality of switches to a closed state based on the charge state of the first battery, wherein the second switch is disposed between the first switch and the second battery.

In other features, the first battery and the second battery comprise low-voltage batteries.

In other features, the first battery and the second battery provide power to corresponding power-distribution boards within the vehicle.

In other features, the controller is further programmed to compare the charge state of the first battery to a predetermined charge threshold when a power-distribution board connected to the first battery is at least one of uploading data or downloading data and selectively transitions the first switch to the closed state based on the comparison.

In other features, the electrical transfer device includes charge sensing circuitry disposed between at least one interface of the plurality of interfaces and the controller, wherein the charge sensing circuitry measures the charge state of the first battery and provides a signal indicative of the charge state to the controller.

A method includes receiving, at a controller, an electrical charge signal indicative of a charge state of a first battery, wherein the first battery is connected to a power-distribution board; comparing the charge state of the first battery to a predetermined charge threshold; and causing at least a first switch of a plurality of switches to transition from an open state to a closed state based on the comparison, wherein the first switch electrically connects the first battery to a second battery of the vehicle in the closed state.

In other features, the method includes causing at least a second switch of the plurality of switches to transition to a closed state based on the comparison, wherein the second switch is disposed between the first switch and the second battery.

In other features, the first battery and the second battery comprise low-voltage batteries.

In other features, the first battery and the second battery provide power to corresponding power-distribution boards within the vehicle.

In other features, the method includes comparing the charge state of the first battery to the predetermined charge threshold when the power-distribution board connected to the first battery is at least one of uploading data or downloading data.

In other features, the method includes receiving the electrical charge signal from charge sensing circuitry disposed between at least one interface and the controller.

In other features, the charge sensing circuitry measures the charge state of the first battery and provides a signal indicative of the charge state to the controller.

Vehicles with advanced driver-assist technology, semi-autonomous, and/or autonomous vehicles can demand a high amount of electrical power. This electrical power is primarily used in powering sensors and the computers used in processing the data collected by the sensors. In some instances, vehicles may require additional data to update one or more vehicle systems. For example, a vehicle guidance system may require downloaded data to improve the accuracy of maps for navigation. During data transfer, the various components require continuous electrical power distribution, and some data transfers may require many minutes, e.g., up to forty (40) minutes, to complete.

In some instances, vehicles may include ports for shore power, e.g., provisioning of electrical power while the vehicle engine is inactive. However, the circuitry for shore power can increase vehicle complexity and cost.

As discussed herein, an electrical transfer device can be temporarily installed in a vehicle for the rerouting of charge between the batteries of the vehicle. For example, the electrical transfer device can determine whether a battery needs additional charge to complete data transfer and electrically connect another vehicle battery for charging purposes. Once the data transfer is complete, the electrical transfer device can be removed from the vehicle. The electrical transfer device may be a standalone device that can be temporarily installed when one or more vehicle systems require a data transfer.

With reference to the Figures, a vehicle 30 includes at least one low-voltage battery 32 electrically coupled to a powertrain 34, and a computer 36 programmed to put the vehicle 30 in a minimal risk condition in response to a state of charge of the low-voltage battery 32 falling below a threshold.

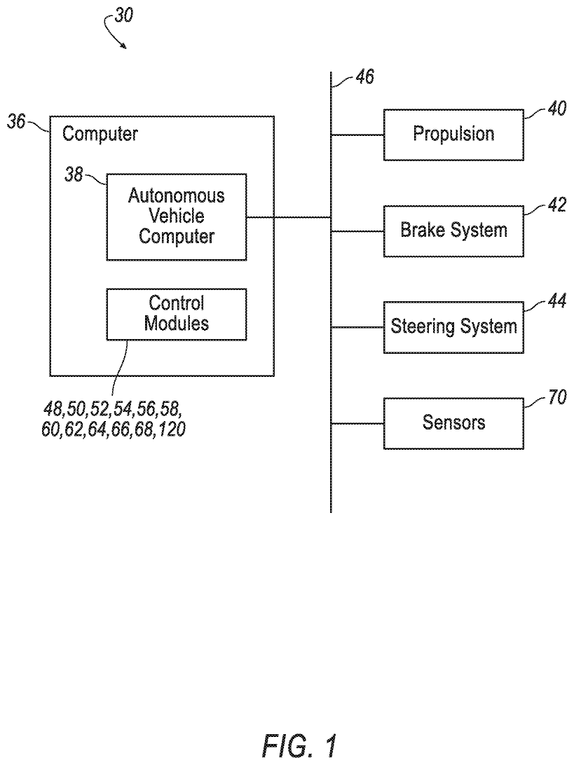

With reference to FIG. 1, the vehicle 30 may be an autonomous or semi-autonomous vehicle. An autonomous-vehicle computer 38 can be programmed to operate the vehicle 30 independently of the intervention of a human driver, completely or to a lesser degree. The autonomous-vehicle computer 38 may be programmed to operate a propulsion 40, brake system 42, steering system 44, and/or other vehicle systems. For the purposes of this disclosure, autonomous operation means the autonomous-vehicle computer 38 controls the propulsion 40, brake system 42, and steering system 44 without input from a human driver; semi-autonomous operation means the autonomous-vehicle computer 38 controls one or two of the propulsion 40, brake system 42, and steering system 44 and a human driver controls the remainder; and nonautonomous operation means a human driver controls the propulsion 40, brake system 42, and steering system 44.

The autonomous-vehicle computer 38 is a microprocessor-based computer. The autonomous-vehicle computer 38 includes a processor, memory, etc. The memory of the autonomous-vehicle computer 38 includes memory for storing instructions executable by the processor as well as for electronically storing data and/or databases.

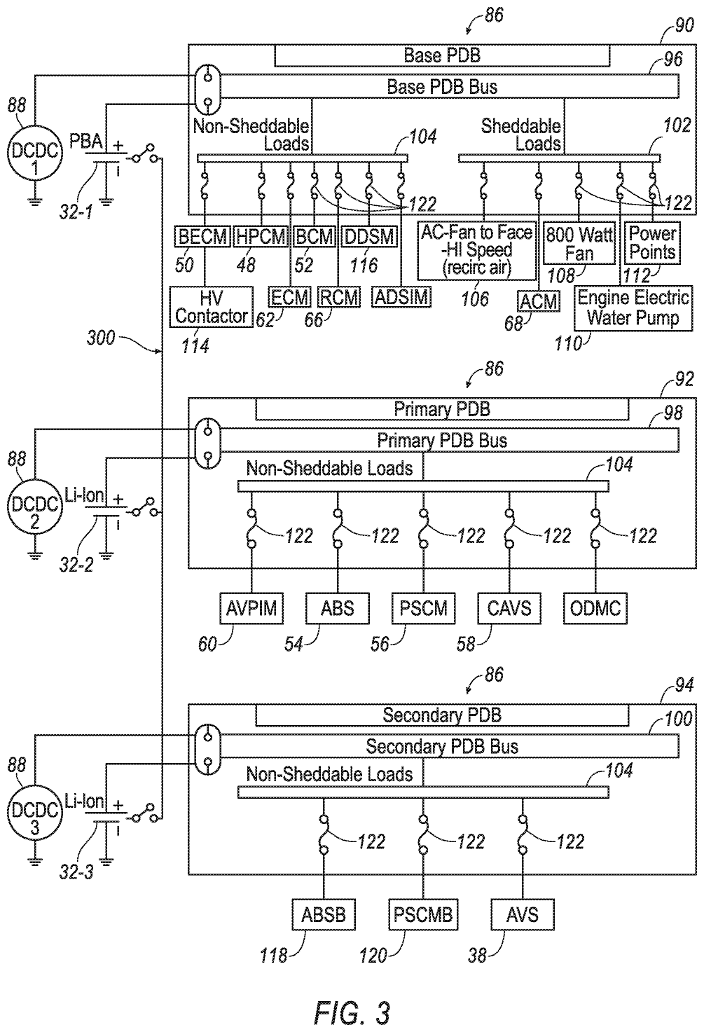

The computer 36 is one or more microprocessor-based computers. The computer 36 includes memory, at least one processor, etc. The memory of the computer 36 includes memory for storing instructions executable by the processor as well as for electronically storing data and/or databases. The computer 36 may be the same computer as the autonomous-vehicle computer 38, or the computer 36 may be one or more separate computers in communication with the autonomous-vehicle computer 38 via a communications network 46, or the computer 36 may encompass multiple computers including the autonomous-vehicle computer 38. As a separate computer, the computer 36 may be or include one or more electronic control units or modules (ECU or ECM) that can be included in a vehicle, e.g., a hybrid-powertrain control module 48 and/or a battery-energy control module 50. Other ECMs may include a body control module 52, an antilock brake control module 54, a first power-steering control module 56, a second power-steering control module 120, a collision-mitigation-system control module 58, an autonomous-vehicle platform-interface control module 60, an engine control module 62, an object-detection maintenance control module 64, a restraint control module 66, and an accessory control module 68 (shown in FIG. 3).

The computer 36 may transmit and receive data through the communications network 46, which may be a controller area network (CAN) bus, Ethernet, WiFi, Local Interconnect Network (LIN), onboard diagnostics connector (OBD-II), and/or by any other wired or wireless communications network. The computer 36 may be communicatively coupled to the autonomous-vehicle computer 38, the other ECMs 48, 50, 52, 54, 56, 58, 60 62, 64, 66, 68, the propulsion 40, the brake system 42, the steering system 44, sensors 70, and other components via the communications network 46.

The sensors 70 may provide data about operation of the vehicle 30, for example, wheel speed, wheel orientation, and engine and transmission data (e.g., temperature, fuel consumption, etc.). The sensors 70 may detect the location and/or orientation of the vehicle 30. For example, the sensors 70 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 70 may detect the external world, e.g., objects and/or characteristics of surroundings of the vehicle 30, such as other vehicles, road lane markings, traffic lights and/or signs, pedestrians, etc. For example, the sensors 70 may include radar sensors, scanning laser range finders, light detection and ranging (LIDAR) devices, and image processing sensors such as cameras. The sensors 70 may include communications devices, for example, vehicle-to-infrastructure (V2I) or vehicle-to-vehicle (V2V) devices.

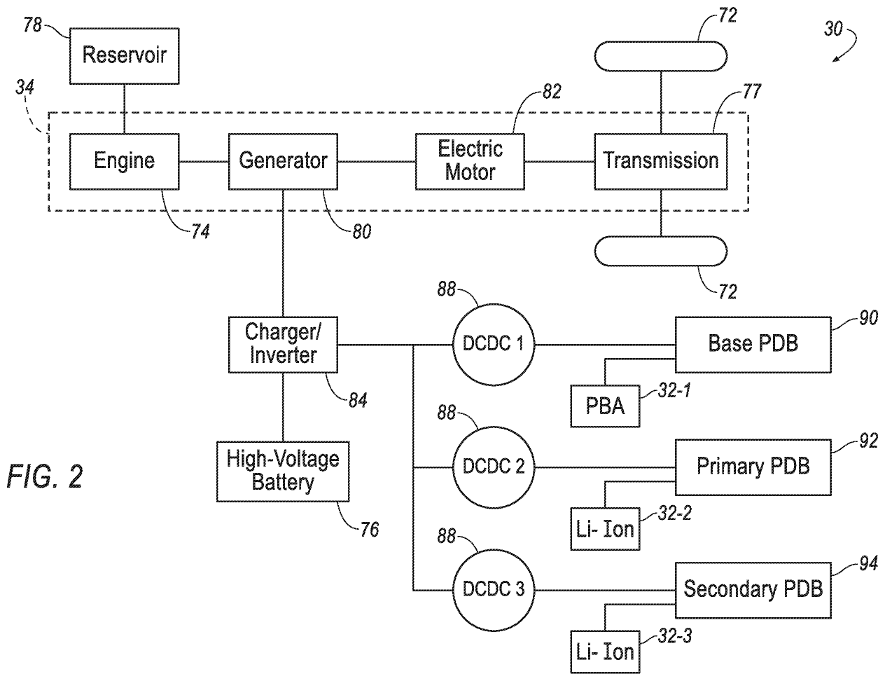

The propulsion 40 of the vehicle 30 generates energy and translates the energy into motion of the vehicle 30. In particular, the propulsion 40 may be hybrid propulsion. The propulsion 40 may include the powertrain 34 in any hybrid arrangement, e.g., a series-hybrid powertrain (as shown in FIG. 2), a parallel-hybrid powertrain, a power-split (series-parallel) hybrid powertrain, etc. The propulsion 40 is described in more detail below with respect to FIG. 2. The propulsion 40 can include an electronic control unit (ECU) or the like that is in communication with and receives input from the autonomous-vehicle computer 38 and/or a human driver, e.g., the hybrid-powertrain control module 48. The human driver may control the propulsion 40 via, e.g., an accelerator pedal and/or a gear-shift lever.

The brake system 42 is typically a conventional vehicle braking subsystem and resists the motion of the vehicle 30 to thereby slow and/or stop the vehicle 30. The brake system 42 may include friction brakes such as disc brakes, drum brakes, band brakes, etc.; regenerative brakes; any other suitable type of brakes; or a combination. The brake system 42 can include an electronic control unit (ECU) or the like that is in communication with and receives input from the autonomous-vehicle computer 38 and/or a human driver, e.g., the antilock brake control module 54. The human driver may control the brake system 42 via, e.g., a brake pedal.

The steering system 44 is typically a conventional vehicle steering subsystem and controls the turning of wheels 72. The steering system 44 may be a rack-and-pinion system with electric power-assisted steering, a steer-by-wire system, as both are known, or any other suitable system. The steering system 44 can include an electronic control unit (ECU) or the like that is in communication with and receives input from the autonomous-vehicle computer 38 and/or a human driver, e.g., the first and/or second power-steering control modules 56, 120. The human driver may control the steering via, e.g., a steering wheel.

With reference to FIG. 2, the propulsion 40 includes the powertrain 34 that transmits power from an engine 74, from a high-voltage battery 76, or from both the engine 74 and the high-voltage battery 76, to a transmission 77 and ultimately to the wheels 72 of the vehicle 30. The engine 74 is an internal-combustion engine and may include cylinders that serve as combustion chambers that convert fuel from a reservoir 78 to rotational kinetic energy. A generator 80 may receive the rotational kinetic energy from the engine 74. The generator 80 converts the rotational kinetic energy into electricity, e.g., alternating current, and powers an electric motor 82. A charger/inverter 84 may convert the output of the generator 80, e.g., the alternating current, into high-voltage direct current to supply the high-voltage battery 76 and a power-distribution system 86. For the purposes of this disclosure, “high voltage” is defined as at least 60 volts direct current or at least 30 volts alternating current. For example, the high-voltage direct current may be on the order of 400 volts. The charger/inverter 84 controls how much power is supplied from the high-voltage battery 76 to the generator 80 of the powertrain 34. The electric motor 82 may convert the electricity from the generator 80 into rotational kinetic energy transmitted to the transmission 77. The transmission 77 transmits the kinetic energy via, e.g., a drive axle to the wheels 72, while applying a gear ratio allowing different tradeoffs between torque and rotational speed.

The high-voltage battery 76 produces a voltage of at least 60 volts direct current, e.g., on the order of 400 volts direct current. The high-voltage battery 76 may be any type suitable for providing high-voltage electricity for operating the vehicle 30, e.g., lithium-ion, lead-acid, etc. The high-voltage battery 76 is electrically coupled to the powertrain 34 via the charger/inverter 84.

With reference to FIG. 3, the power-distribution system 86 may include a plurality of DC/DC converters 88. The DC/DC converters 88 are electrically coupled to the powertrain 34 via the charger/inverter 84 (as shown in FIG. 2) and to the low-voltage batteries 32. The DC/DC converters 88 may receive high-voltage direct current from the charger/inverter 84 and/or the high-voltage battery 76 and convert the high-voltage direct current to low-voltage direct current. For the purposes of this disclosure, “low voltage” is defined as less than 60 volts direct current or less than 30 volts alternating current. For example, the low-voltage direct current may be 12 volts or 48 volts. Each DC/DC converter 88 may exchange the low-voltage direct current with one of the low-voltage batteries 32, and each DC/DC converter 88 may supply the low-voltage direct current to one of a plurality of power-distribution-board buses 96, 98, 100.

A plurality of power-distribution boards 90, 92, 94 include a base power-distribution board 90, a primary power-distribution board 92, and a secondary power-distribution board 94. The power-distribution boards 90, 92, 94 divide electricity into subsidiary circuits, i.e., a plurality of loads 102, 104. A load is a device that consumes electrical power. Thus, a load 102, 104 may be an electrical component or portion of a circuit that consumes electric power, such as sheddable loads 102 and nonsheddable loads 104 described in greater detail below. The power-distribution boards 90, 92, 94 each include one of the power-distribution board buses and one or more fuses 122. The power-distribution-board buses 96, 98, 100 include a base power-distribution-board bus 96 in the base power-distribution board 90, a primary power-distribution-board bus 98 in the primary power-distribution board 92, and a secondary power-distribution-board bus 100 in the secondary power-distribution board 94.

The low-voltage batteries 32 each produces a voltage less than 60 volts direct current, e.g., 12 or 48 volts direct current. The low-voltage batteries 32 may be any type suitable for providing low-voltage electricity for power the loads 102, 104, e.g., lithium-ion, lead-acid, etc. For example, the low-voltage battery 32 electrically coupled to the base power-distribution board 90 is a lead-acid battery, and the low-voltage batteries 32 electrically coupled to the primary power-distribution board 92 and to the secondary power-distribution board 94 are lithium-ion batteries. The low-voltage batteries 32 are electrically coupled to the powertrain 34 via the respective DC/DC converter 88 and the charger/inverter 84.

The loads 102, 104 include sheddable loads 102 and nonsheddable loads 104. For the purposes of this disclosure, a “sheddable load” is defined as a load designated to be powered off when the loads 102, 104 demand more power than available, and a “nonsheddable load” is defined as a load designated to remain powered when the loads 102, 104 demand more power than available. The sheddable loads 102 may include, e.g., an air-conditioning system 106 or components or settings of the air-conditioning system 106 such as an AC fan or a high-speed mode; the accessory control module 68; a fan 108 for cooling the engine 74; an electric water pump 110 for the engine 74; and power points 112 (i.e., sockets in a passenger cabin for passengers to plug in personal devices), as shown in FIG. 3. The nonsheddable loads 104 may include, e.g., the battery-energy control module 50, a high-voltage contactor 114 for the battery-energy control module 50 to control electricity flow to the DC/DC converters 88, etc., the hybrid-powertrain control module 48, the engine control module 62, the body control module 52, the restraint control module 66, a data recorder 116 (as shown in FIG. 3), the autonomous-vehicle platform-interface control module 60, the antilock brake control module 54, the power-steering control module 56, the collision-mitigation-system control module 58 (as shown in FIG. 3), the object-detection maintenance control module 64, an antilock-brake-system backup 118, the second power-steering control module 120, and the autonomous-vehicle computer 38.

In normal operation, the loads 102, 104 are typically powered via the DC/DC converters 88 without drawing power from the low-voltage batteries 32. The low-voltage batteries 32 supply power in the event of transient demands from the loads 102, 104 for greater power than the DC/DC converters 88 can supply.

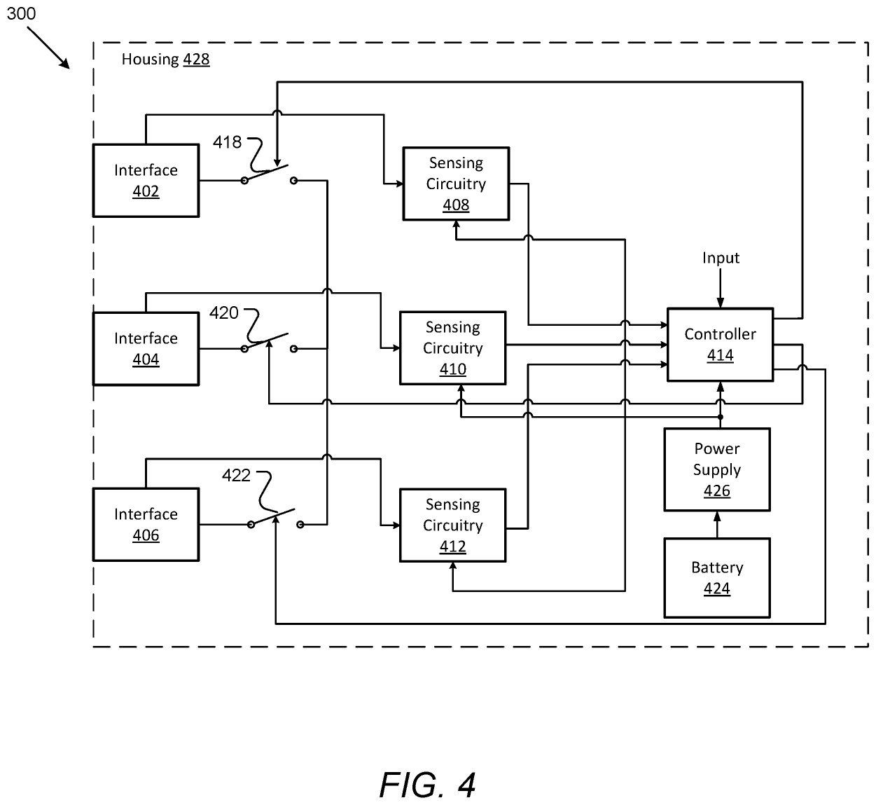

As shown in FIG. 3, an electrical transfer device 300 can be connected to the batteries 32-1, 32-2, 32-3. As discussed in greater detail below with respect to FIG. 4, the electrical transfer device 300 allows for charging of one or more of the batteries 32-1, 32-2, 32-3 when the engine 72 is inactive and one or more components of the power-distribution boards 90, 92, 94 is receiving or uploading data during a data transfer. For example, during a data transfer, the electrical transfer device 300 can reroute charge from one battery 32-1, 32-2, 32-3 to another battery 32-1, 32-2, 32-3 such that the components of the power-distribution boards 90, 92, 94 can receive sufficient electrical power to perform the data transfer without the support of the engine 72. In one or more implementations, the electrical transfer device 300 is a removable device such that the electrical transfer device 300 can be removed after the data transfer is complete.

FIG. 4 illustrates an example electrical transfer device 300. The electrical transfer device 300 includes interfaces 402, 404, 406 that electrically interface with corresponding batteries 32-1, 32-2, 32-3 (shown in FIG. 3). In an example implementation, the interfaces 402, 404, 406 can comprise connectors, clamps, or the like. The electrical transfer device 300 also includes sensing circuitry 408, 410, 412 that receives an electrical charge from the corresponding interfaces 402, 404, 406. The sensing circuitry 408, 410, 412 receives the electrical charge and outputs a sensed electrical charge signal to a controller 414. The controller 414 is a microprocessor-based computer that includes a processor, memory, etc. The memory of the controller 414 includes memory for storing instructions executable by the processor as well as for electronically storing data and/or databases. In an example implementation, the controller 414 comprises a standalone microprocessor-based computer within the electrical transfer device 300.

The sensed electrical charge signal is indicative of a state of charge (SoC), i.e., charge state, associated with the corresponding batteries 32-1, 32-2, 32-3. The charge state of the low-voltage batteries 32-1, 32-2, 32-3 can thus be determined via any suitable technique and can vary between 0 (zero, i.e., no remaining charge) and 100% (fully charged). In various implementations, the sensing circuitry 408, 410, 412 can comprise suitable electronic components, such as an amplifier or the like.

The controller 414 receives the sensed electrical charge signal as input and controls switches 418, 420, 422 based on the sensed electrical charge signal. The switches 418, 420, 422 can transition between an open state, and a closed state, based on control signals generated by the controller 414. The switches 418, 420, 422 can comprise any suitable electrical component that can disconnect or connect a conducting path between the batteries 32-1, 32-2, 32-3 based on the control signals. For example, the switches 418, 420, 422 may comprise a relay, such as a solid-state relay (SSR), a transistor, such as a metal-oxide-semiconductor field-effect transistor (MOSFET), or the like.

When the switches 418, 420, 422 are in the open state, the switches 418, 420, 422 at least substantially prevent the flow of current between the various batteries 32-1, 32-2, 32-3. When the switches 418, 420, 422 are in the closed state, the switches 418, 420, 422 allow the flow of current between at least two batteries 32-1, 32-2, 32-3. As described in greater detail below, the controller 414 can control the switches 418, 420, 422 to transfer energy between the batteries 32-1, 32-2, 32-3 based on the sensed electrical charge signals.

In an example implementation, the controller 414 includes a microprocessor-based computer. The controller 414 includes at least a processor and memory. The memory of the controller 414 includes memory for storing instructions executable by the processor as well as for electronically storing data and/or databases.

The electrical transfer device 300 also includes a battery 424 and a power supply 426. The battery 424 supplies power to the power supply 426, and the power supply 426 distributes power to various components within the electrical transfer device 300. In various implementations, the battery 426 includes a rechargeable lithium-ion battery. The power supply 426 provides power to a controller 414 and/or the sensing circuitry 408, 410, 412. From the power provided by the battery 426, the power supply may generate one or more voltages of power for distribution. For example, the power supply 426 may include one or more voltage regulators and one or more DC-DC conversion circuits, such as a boost circuit, a buck circuit, or a boost/buck circuit.

The controller 414 is programmed to determine whether at least one battery 32-1, 32-2, 32-3 is to receive an energy transfer based on the state of charge of the at least one battery 32-1, 32-2, 32-3. Based on the determination, the controller 414 causes at least two switches 418, 420, 422 to transition from the open state to the closed state to allow charge transfer from one battery 32-1, 32-2, 32-3 to another. The controller 414 can receive input from one or more other controllers of the power-distribution boards 90, 92, 94 to determine when data transfer is occurring.

In an example implementation, the controller 414 determines that at least one battery 32-1, 32-2, 32-3 is below a predetermined charge threshold. For example, when the engine 74 is inactive and the power distribution system 86 is receiving a data transfer, the controller 414 monitors the state of charge of the batteries 32-1, 32-2, 32-3. An engine 74 can be defined as inactive when the engine 74 is not providing power to the powertrain 34. If additional data is to be downloaded by one of the power-distribution boards 90, 92, 94 during the data transfer and the corresponding battery 32-1, 32-2, 32-3 for the power-distribution board 90, 92, 94 has a state of charge below the predetermined charge threshold, the controller 414 transitions the corresponding switches 418, 420, 422 from the open state to the closed state to charge the battery 32-1, 32-2, 32-3.

The predetermined charge threshold can be selected based on empirically determined charge states of the batteries 32-1, 32-2, 32-3, such as a minimum charge state to prolong battery life. In an example implementation, the minimum charge state is based on data supplied by a battery monitor sensor that reports a battery's state-of-charge (SoC), a battery's temperature, a battery's voltage, a battery's current, or the like. In another example implementation, the minimum charge state is based on data supplied by a LV battery built-in Battery Electronics Control Module (BECM) that reports the battery's SoC, state-of-energy (SoE), temperature, voltage, current, or the like.

The controller 414 can determine which battery 32-1, 32-2, 32-3 is to supply charge based on a charge state of the batteries 32-1, 32-2, 32-3. The controller 414 can select a battery 32-1, 32-2, 32-3 to supply charge to the battery 32-1, 32-2, 32-3 corresponding to the power-distribution boards 90, 92, 94 receiving the data when the battery 32-1, 32-2, 32-3 to supply the charge has the highest charge state among the batteries 32-1, 32-2, 32-3. Once the battery 32-1, 32-2, 32-3 is selected, the controller 414 transmits a control signal to the switches 418, 420, 422 corresponding to the selected battery 32-1, 32-2, 32-3 and the battery 32-1, 32-2, 32-3 of the power-distribution boards 90, 92, 94 receiving the data.

The electrical transfer device 300 can include a housing 428 that encloses one or more the components of the electrical transfer device 300. The housing 428 can comprise any suitable material that allows the components of the electrical transfer device 300 to be enclosed therein. For example, the housing 428 can comprise a composite material, a polyethylene terephthalate material, or the like. The housing 428 can also include one or more ports to allow for interfacing with one or more components, such as the controller 414, the battery 426, or the like.

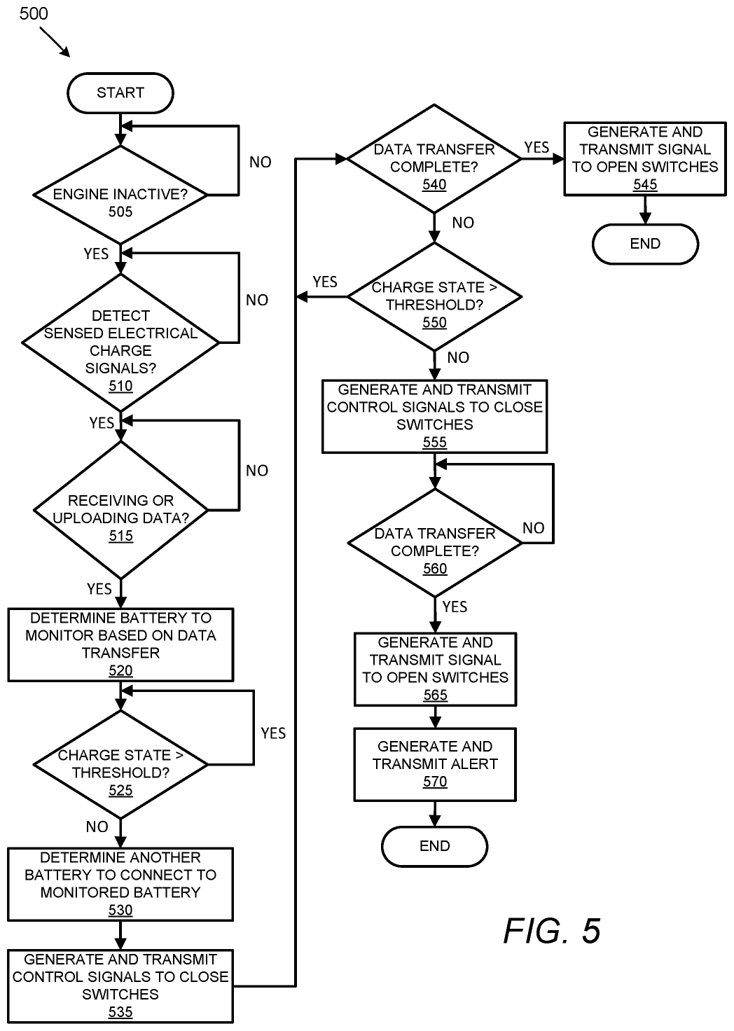

FIG. 5 is a process flow diagram illustrating an example process 500 for electrically connecting a first battery 32-1, 32-2, 32-3 to a second battery 32-1, 32-2, 32-3 for charge transfer. The memory of the controller 414 stores executable instructions for performing the steps of the process 500.

The process 500 can begin once the electrical transfer device 300 is connected with the batteries 32-1, 32-2, 32-3. For instance, the electrical transfer device 300 may be manually installed during periods when the vehicle 30 is inactive, e.g., the engine 74 is inactive. Once the electrical transfer device 300 is connected to the batteries 32-1, 32-2, 32-3, the controller 414 may be transitioned from an inactive state to an active state. Inactive refers to a state in which the controller 414 is in a powered-down state, and an active state refers to a state in which the controller 414 is operating as described herein. An operator can manually actuate the controller 414 from the inactive state to the active state, and vice versa.

At block 505, the controller 414 determines whether the engine 74 is inactive. If the engine is active, the process 500 returns to block 505. The controller 414 can determine that the engine 74 is inactive via an absence of a signal from the engine control module 62. The controller 414 can determine whether the engine 74 is inactive once the controller 414 is activated, e.g., once the operator connects the electrical transfer device 300 and actuates the controller 414. If the engine 74 is inactive, the controller 414 determines whether one or more sensed electrical charge signals have been detected at block 510. If the controller 414 determines that no sensed electrical charge signals have been received, the process 500 returns to block 510. The controller 414 can determine the presence of electrical charge signals based on receiving electrical charge signals from at least one of the sensing circuitry 408, 410, 412. The controller 414 can also determine the absence of electrical charge signals, i.e., that no sensed electrical charge signals have been received, when the controller 414 does not detect electrical charge signals. Otherwise, at block 515, the controller 414 determines whether at least one of the power-distribution boards 90, 92, 94 is receiving or uploading data during a data transfer. The controller 414 can determine whether at least one power-distribution boards 90, 92, 94 is receiving data based on one or more data transfer signals received from a controller of the power-distribution boards 90, 92, 94. If no data transfers signals have been received, the process 500 returns to block 515. In some implementations, the controller 414 can initiate a counter to compare with a predetermined time threshold. The predetermined time threshold may be set by an operator. If no electrical charge signals and/or no data transfer signals have been received within the predetermined time threshold, the controller 414 generates an alert indicating no electrical charge signals and/or no data transfer signals have been received. The alert may be transmitted to an electronic device of the operator.

Otherwise, based on received data transfer signals, the controller 414 identifies which battery 32-1, 32-2, 32-3 to monitor at block 520. The controller 414 identifies the battery 32-1, 32-2, 32-3 to monitor upon on the power-distribution board 90, 92, 94 receiving or uploading data during the data transfer based on the battery 32-1, 32-2, 32-3 having the greatest remaining charge. The controller 414 compares the charge state of the identified battery 32-1, 32-2, 32-3 to the predetermined charge threshold at block 525. If the charge state of the identified battery 32-1, 32-2, 32-3 is greater than the predetermined charge threshold, the process 500 returns to block 525. If the charge state is less than or equal to the predetermined charge threshold, the controller 414 determines a battery 32-1, 32-2, 32-3 to electrically connect to the identified, e.g., monitored, battery 32-1, 32-2, 32-3 for charging at block 530. As discussed above, the controller 414 can be programmed to determine which battery 32-1, 32-2, 32-3 to use based on a charge state. Once the controller 414 selects a battery 32-1, 32-2, 32-3 for charging, the controller 414 generates and transmits control signals to the switches 418, 420, 422 corresponding to the selected battery 32-1, 32-2, 32-3 and the battery 32-1, 32-2, 32-3 of the power-distribution board 90, 92, 94 receiving the data at block 535.

At block 540, the controller 414 determines whether the data transfer is complete. In an example implementation, a controller of the power-distribution board 90, 92, 94 involved in the data transfer transmits a data transfer completion signal to the controller 414 indicating the data transfer is complete. The data transfer may be completed once the data to transfer has been uploaded or downloaded. If the data transfer is complete, the controller 414 generates and transmits controls signals to the switches 418, 420, 422 that are in the closed state at block 545, and the process 500 ends.

If the data transfer is not complete, the controller 414 compares the charge state of the charging battery 32-1, 32-2, 32-3 to the predetermined charge threshold at block 550. If the charge state is greater than the predetermined charge threshold, the process 500 returns to block 540. If the charge state is less than or equal to the predetermined charge threshold, the controller 414 generates and transmits control signals to the switch 418, 420, 422 such that the remaining battery 32-1, 32-2, 32-3 takes over charging the battery 32-1, 32-2, 32-3 of the power-distribution board 90, 92, 94 receiving the data at block 555. The controller 414 determines whether the data transfer is complete at block 560. If the data transfer is not complete, the process 500 returns to block 560. Otherwise, the controller 414 generates and transmits controls signals to the switches 418, 420, 422 that are in the closed state at block 565 to transition the switches 418, 420, 422 to the open state. At block 570, the controller 414 outputs to a user interface a message that the electrical transfer device 300 can be removed from the vehicle 30, and the process 500 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The disclosure has been described in an illustrative manner, and it is to be understood that the terminology which has been used is intended to be in the nature of words of description rather than of limitation. Use of “in response to” and “upon determining” indicates a causal relationship, not merely a temporal relationship. Many modifications and variations of the present disclosure are possible in light of the above teachings, and the disclosure may be practiced otherwise than as specifically described.

1. An electrical transfer device comprising:
a plurality of switches;
a plurality of interfaces removably couplable with a corresponding battery of a vehicle, wherein each switch of the plurality of switches is connected to an interface of the plurality of interfaces and another switch of the plurality of switches; and
a controller programmed to transition at least a first switch of the plurality of switches from an open state to a closed state based on a charge state of a first battery, wherein the first switch electrically connects the first battery to a second battery of the vehicle in the closed state;
wherein the controller is further programmed to determine that a power-distribution board connected to the first battery is at least one of uploading data or downloading data based on receiving a data transfer signal, and upon determining that the power-distribution board is uploading or downloading data based on receiving the data transfer signal, compare the charge state of the first battery to a predetermined charge threshold.

2. The electrical transfer device of claim 1, wherein the controller is further programmed to transition at least a second switch of the plurality of switches to a closed state based on the charge state of the first battery, wherein the second switch is disposed between the first switch and the second battery.

3. The electrical transfer device of claim 2, wherein the first battery and the second battery comprise low-voltage batteries.

4. The electrical transfer device of claim 2, wherein the power-distribution board is a first power-distribution board, the first battery provides power to the first power-distribution board, and the second battery provides power to a second power-distribution board within the vehicle.

5. (canceled)

6. The electrical transfer device of claim 1, further comprising charge sensing circuitry disposed between at least one interface of the plurality of interfaces and the controller, wherein the charge sensing circuitry measures the charge state of the first battery and provides a signal indicative of the charge state to the controller.

7. The electrical transfer device of claim 6, wherein the sensing circuitry comprises an amplifier.

8. An electrical transfer device comprising:
a plurality of switches;
a plurality of interfaces removably couplable with a corresponding battery of a vehicle, wherein each switch of the plurality of switches is connected to an interface of the plurality of interfaces and another switch of the plurality of switches;
a controller programmed to transition at least a first switch of the plurality of switches from an open state to a closed state based on a charge state of a first battery, wherein the first switch electrically connects the first battery to a second battery of the vehicle in the closed state; and
a housing that at least partially encloses the plurality of switches, the plurality of interfaces, and the controller;
wherein the housing is removable from the vehicle; and
the controller is further programmed to determine that a power-distribution board connected to the first battery is at least one of uploading data or downloading data based on receiving a data transfer signal, and upon determining that the power-distribution board is uploading or downloading data based on receiving the data transfer signal, compare the charge state of the first battery to a predetermined charge threshold.

9. The electrical transfer device of claim 8, wherein the controller is further programmed to transition at least a second switch of the plurality of switches to a closed state based on the charge state of the first battery, wherein the second switch is disposed between the first switch and the second battery.

10. The electrical transfer device of claim 9, wherein the first battery and the second battery comprise low-voltage batteries.

11. The electrical transfer device of claim 9, wherein the first battery provides power to the power-distribution board, and the second battery provides power to a second power-distribution board within the vehicle.

12. (canceled)

13. The electrical transfer device of claim 8, further comprising charge sensing circuitry disposed between at least one interface of the plurality of interfaces and the controller, wherein the charge sensing circuitry measures the charge state of the first battery and provides a signal indicative of the charge state to the controller.

14. A method comprising:
receiving, at a controller, an electrical charge signal indicative of a charge state of a first battery, wherein the first battery is connected to a power-distribution board;
determining that the power-distribution board connected to the first battery is at least one of uploading data or downloading data based on receiving a data transfer signal;
upon determining that the power-distribution board is uploading or downloading data based on receiving the data transfer signal, comparing the charge state of the first battery to a predetermined charge threshold; and
causing at least a first switch of a plurality of switches to transition from an open state to a closed state based on the comparison, wherein the first switch electrically connects the first battery to a second battery of the vehicle in the closed state.

15. The method of claim 14, further comprising: causing at least a second switch of the plurality of switches to transition to a closed state based on the comparison, wherein the second switch is disposed between the first switch and the second battery.

16. The method of claim 15, wherein the first battery and the second battery comprise low-voltage batteries.

17. The method of claim 15, wherein the first battery and the second battery provide power to corresponding power-distribution boards within the vehicle.

18. (canceled)

19. The method of claim 14, further comprising: receiving the electrical charge signal from charge sensing circuitry disposed between at least one interface and the controller.

20. The method of claim 19, wherein the charge sensing circuitry measures the charge state of the first battery and provides a signal indicative of the charge state to the controller.

21. The electrical transfer device of claim 1, wherein the controller is further programmed to determine that the power-distribution board has completed uploading or downloading data, and upon determining that the power-distribution board has completed uploading or downloading data, transition the plurality of switches to the open state.

22. The method of claim 14, further comprising determining that the power-distribution board has completed uploading or downloading data, and upon determining that the power-distribution board has completed uploading or downloading data, transitioning the plurality of switches to the open state.

23. The electrical transfer device of claim 1, wherein the controller is further programmed to determine that an engine of the vehicle is active, and upon determining that the engine is active, refrain from transitioning the plurality of switches.
